(19) United States
(12) Patent Application Publication
(10) Pub. No.: US 2012/0285221 A1
(43) Pub. Date: Nov. 15, 2012

(54) ACOUSTIC PROBE FOR LEAK DETECTION IN WATER PIPELINES

(75) Inventors: Hussain Al-Qahtani, Dhahran (SA); Yagoub N. Al-Nassar, Dhahran (SA); Muhammad A. Hawwa, Dhahran (SA); Kamal Youcef-Toumi, Cambridge, MA (US)

(73) Assignees: King Fahd University of Petroleum and Minerals, Dhahran (SA); Massachusetts Institute of Technology, Cambridge, MA (US)

(21) Appl. No.: 13/412,718

(22) Filed: Mar. 6, 2012

Related U.S. Application Data
(60) Provisional application No. 61/485,675, filed on May 13, 2011.

(51) Int. Cl. G01M 3/24

(52) U.S. Cl. 73/40.5 A

(57) ABSTRACT

Acoustic system for leak detection. The system includes a disk-shaped probe for insertion into fluid flowing within a pipe. The probe has a convex front surface facing in the flow direction and a substantially flat rear surface. The probe further includes wheels to engage a pipe wall to maintain the probe's orientation within the pipe. At least one pressure sensor is embedded in the probe and is responsive to pressure changes resulting from a leak in the pipe wall. Data collection circuitry is disposed in the probe to receive probe location data and to receive an acoustic signal from the pressure sensor from which the pressure and location of a leak may be determined.

This application claims priority to provisional application No. 61/485675 filed on May 13, 2011, the contents of which is incorporated herein by reference.

### BACKGROUND OF THE INVENTION

This invention relates to leak detection and more particularly to an acoustic probe for traversing the inside of a pipe to monitor an acoustic signal indicating a leak.

Water leaks from underground water pipelines result in loss of revenue and present the potential for causing hazardous conditions. The locations of such leaks are sometimes very difficult to pinpoint.

It is common practice to install water pipelines underground. In this case, when a leak occurs, the actual location of the leak is not visible. Given the substantial costs associated with excavation of the ground surrounding a leaking underground water pipeline, it is critical that the locations of such leaks be readily specified to minimize the extent of any excavations that may be required and to avoid unnecessary excavations so as to limit the amount of labor and time required to locate the leak.

Water flowing in pipelines is under pressure due to pumping. When a pipeline leaks, it causes a pressure drop and thereafter a pressure fluctuation occurs that sends an acoustical signal in both the upstream and downstream directions in the pipe.

Acoustic methods of leak detection have been used by many practicing engineers. Water leaking from underground pipes under pressure typically produces acoustic vibrations with a frequency in the range of about 40 Hz to about 4,000 Hz, i.e., all frequencies that are within the human hearing domain that extends from approximately 20 Hz to 20,000 Hz. Prior acoustic methods used geophones or hydrophones to pick up the sound coming from a leak. When geophones or hydrophones are used both upstream and downstream of the leak, the cross-correlogram of the two signals provides a measure of the distance of the leak from each of the two measuring points and, thus, the location of the leak may be determined by calculations. Background noise levels and acoustic damping due to the surrounding soil have been major problems causing limited utility of acoustic methods employing signal correlation techniques.

Ultrasonic methods of leak detection are also known in the prior art. In the case of an ultrasonic method, a wave is sent into the pipe walls and the transmitted/reflected ultrasound wave is detected. A major disadvantage of using ultrasound is that the inspection is limited to the short lengths of the pipe at which the ultrasound is directed. Therefore, the inspection of a long pipe or a pipeline network would take a major testing effort.

The disadvantages of the above-mentioned methods of leak detection have recently led to a proposal of having probes traveling inside a pipeline network wherein a probe can be inserted into a pipeline and then travel with the water flow while collecting information about leaks over many miles of pipeline with a single deployment [1]. Numbers in brackets refer to the references listed herein. The contents of all of these references are incorporated herein by reference in their entirety.

When the pipeline is made of a “lossy” material (such as PVC), which is quite common in recently established water networks, the acoustic signal generated by the leak is quickly attenuated in the walls of the pipe, thereby making it difficult to detect the signal if a moving probe is not close enough to a defective wall. It has been found that the acoustic signals in plastic/PVC pipes are greatly attenuated [2-5], and leak detection becomes more difficult.

It is an object of the present invention, therefore, to provide internal leak detection that is capable of detecting a low-amplitude acoustic signal resulting from a leak at an early stage in the onset of the leak.

### SUMMARY OF THE INVENTION

In a first aspect, the invention is an acoustic system for leak detection including a disk-shaped probe for insertion into fluid flowing within a pipe, the probe having a convex front surface facing in the flow direction and a substantially flat rear surface. The probe includes wheels to engage the pipe wall to maintain the probe's orientation within the pipe. At least one pressure sensor is embedded in the probe responsive to pressure changes resulting from a leak in the pipe wall. Data collection circuitry is disposed in the probe to receive probe location data and to receive the acoustic signal from the pressure sensor from which the presence and location of a leak may be determined. In a preferred embodiment, the probe further includes wireless communication means for transmitting the probe location and the acoustic signal to a receiver.

In another preferred embodiment, the probe includes three double wheels for maintaining the probe's orientation. It is preferred that the wheels be offset from the pressure sensor so that flow disturbances caused by the wheels do not substantially affect the pressure sensor. It is also preferred that the double wheels be made of a lossy material and are connected by a curved structure.

In yet another aspect of the invention, the acoustic system includes a first disk-shaped probe having a convex front surface and a substantially flat rear surface, the first probe having at least one pressure sensor embedded therein. A second disk-shaped probe is spaced apart from, and connected to, the first probe, the second probe including data collection and/or communication circuitry responsive to the location of the probes and to the pressure sensor.

Thus, the system of the invention maintains the probe near a leak in a pipe wall that can be monitored acoustically.

### BRIEF DESCRIPTION OF THE DRAWING

FIG. 1 is a schematic illustration of an embodiment of the invention disclosed herein.

FIG. 2 includes side, isometric and top views of the embodiment shown in FIG. 1.

FIG. 3 is a schematic illustration of the curved structure connecting a pair of wheels.

FIG. 4 is a schematic illustration of a second embodiment of the invention employing two disk-shaped acoustic probes.

FIG. 5 is a schematic illustration of another embodiment of the invention.

### DESCRIPTION OF THE PREFERRED EMBODIMENT

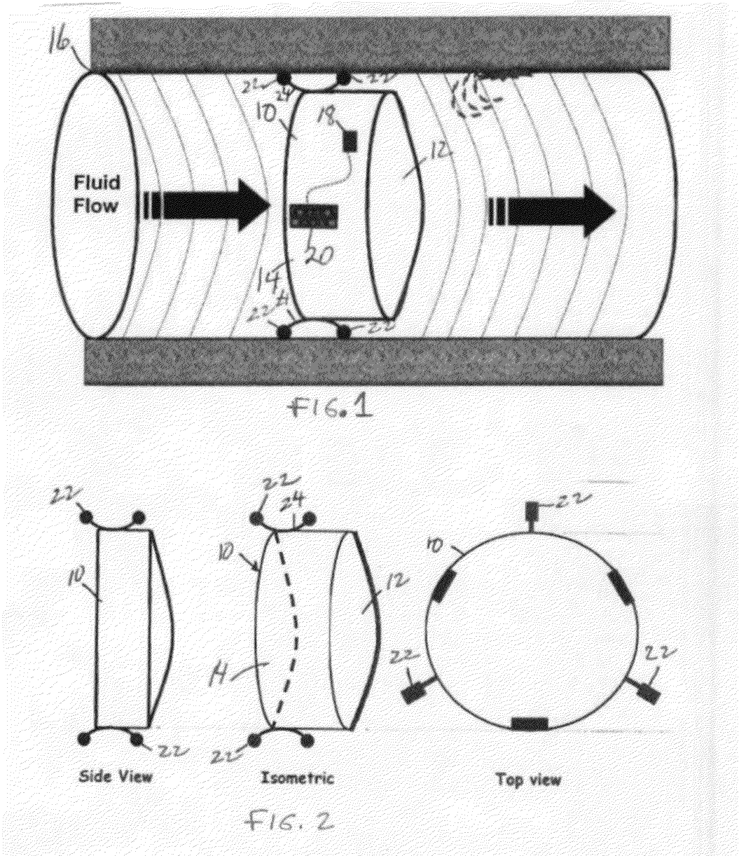

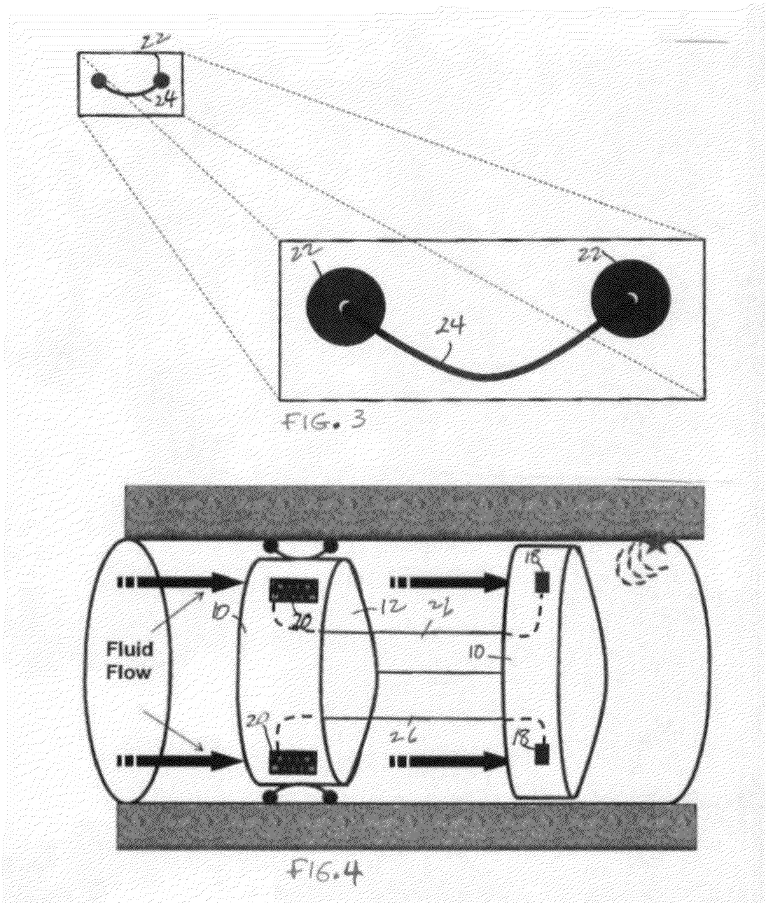

With reference first to FIG. 1 an acoustic probe 10 has a convex front surface 12 and a substantially flat rear surface 14. This configuration is designed so that the probe 10 is driven by the fluid flow at much the same speed of water flowing in a pipe 16. The probe 10 includes an acoustic or pressure sensor 18 that communicates with circuitry 20 that responds to signals from the acoustic or pressure sensor 18. The circuitry 20 either records the acoustic signal or transmits the signal wirelessly to a remote receiver. With reference now to FIGS. 1 and 2, the probe 10 includes wheels 22 that are arranged in pairs connected by a curved structure 24. The wheels 22 are placed away from the acoustic sensor 18 to minimize any disturbances that may be produced by fluid flow around the wheels 22. It is preferred that there be a minimum of three wheel sets 22 to provide for stability.

Those of ordinary skill in the art will recognize that two types of data need to be collected by the probe 10. First of all, the distance moved by the probe needs to be monitored so that the location of the probe when it encounters a leak can be determined. Location of the probe 10 in the pipe 16 can readily be determined by monitoring the number of wheel rotations of the wheels 22. This information is also stored in the circuitry 20 along with the acoustic signal from the acoustic sensor 18 that responds to acoustic energy caused by fluid flow through a leak.

The collected data may be analyzed once the probe has completed its passage through the pipeline to determine the location of a leak or, as said above, data can be communicated wirelessly to a receiving system outside the pipes. It will be apparent that several wireless communication methods are available commercially for data acquisition, including ultrasonic, global positioning system satellites, RF, radar, etc.

The double wheels 22 are made of a lossy material (e.g., rubber) to minimize acoustic noise emission caused by the contact of the wheel 22 with a wall of the pipe 16. As shown in FIG. 3, the curved connection 24 between the wheels 22 also helps in absorbing any shock effects due to discontinuities (e.g., pipe joints, or manufacturing defects) [5].

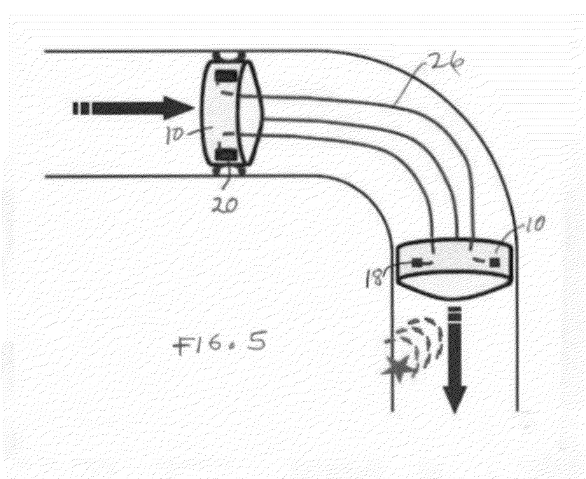

Another embodiment of the invention is shown in FIG. 4. In FIG. 4, two fluid flow-driven disks 10 are designed to perform different functions. The forward disk in FIG. 4 carries the sensing elements 18 and the second disk carries the electronic/data processing units 20. The two disks 10 in FIG. 4 are connected to one another and are spaced apart. The advantage of this embodiment is that since the first disk 10 is a sensing unit, the second disk can have a bigger volume accommodating the electronic processing elements. Also, the possibility of interference between the sensing elements 18 and the processing elements 20 is minimized because of their separation. The two disks 10 are connected by slender elements 26, which host the necessary wiring for acoustic data that has been measured to be transferred to the processing units embedded in the second probe unit.

Another embodiment of the invention is shown in FIG. 5. This embodiment is similar to that in FIG. 4. The first disk 10 includes the sensing elements 18 and the second disk carries the electronics/data processing units 20. The two disks are connected by slender flexible elements 26 that host the necessary wiring so that the disks 10 can share information. The main advantage of flexible connecting elements 26 is to enable the probe system disclosed herein to go smoothly in bends such as the L-shaped section shown in FIG. 5.

It is recognized that modifications and variations of the invention will be apparent to those of ordinary skill in the art and it is intended that all such modifications and variations be included within the scope of the appended claims.

### REFERENCES

1. R. Fletcher, “SmartBall—A new approach in pipeline leak detection,” Proceedings of the International Pipeline Conference, IPC2008, pp. 1-17, Calgary, Alberta, Canada, Sep. 29, Oct. 3,2008.

2. O. Hunaidi, W. Chu, A. Wang, W. Guan, “Detecting leaks in plastic pipes,” Journal of the American Water Works Association, 92 (2), (2000), 82-94.

3. O. Hunaidi, A. Wang, M. Bracken, T. Gambino, C. Fricke, Acoustic methods for locating leaks in municipal water pipe networks, International Conference on Water Demand Management, Dead Sea, 2004, pp. 1-14.

4. J. M. Muggleton, M. J. Brennan, “Leak noise propagation and attenuation in submerged plastic water pipes,” Journal of Sound and Vibration 278 (3) (2004) 527-537.

5. Y. Gao, M. J. Brennan, P. F. Joseph, “A comparison of time delay estimators for the detection of leak noise signals in plastic water distribution pipes,” Journal of Sound and Vibration 292 (2006) 552-570.

6. J. N. Rossettosa and E. Perl, “On the damped vibratory response of curved viscoelastic beams,” Journal of Sound and Vibration, Volume 58, Issue 4,22 June 1978, Pages 535-544.

What is claimed is:

1. Acoustic system for leak detection comprising:
a disk-shaped probe for insertion into fluid flowing within a pipe, the probe having a convex front surface facing in the flow direction and a substantially flat rear surface; the probe further including wheels to engage the pipe wall to maintain the probe's orientation within the pipe;
at least one pressure sensor embedded in the probe responsive to pressure changes resulting from a leak in the pipe wall; and
data collection circuitry disposed in the probe to receive probe location data and to receive an acoustic signal from the pressure sensor from which the presence and location of a leak may be determined.

2. The system of claim 1 wherein the probe further includes wireless communication means for transmitting the probe location and the acoustic signal to a receiver.

3. The system of claim 1 wherein the probe includes three double wheels.

4. The system of claim 1 wherein the wheels are offset from the pressure sensor so that flow disturbances caused by the wheels do not substantially affect the pressure sensor.

5. The system of claim 3 wherein the double wheels are made of a lossy material and are connected by a curved structure.

6. Acoustic system for leak detection comprising:
a first disk-shaped probe having a convex front surface and substantially flat rear surface, the first probe having at least one pressure sensor embedded therein; and
a second disk-shaped probe space apart from and connected to, the first probe, the second probe including data collection and/or communication circuitry responsive to the location of the probes and to the pressure sensor.
